(19) United States
(12) Patent Application Publication
(10) Pub. No.: US 2013/0199323 A1
(43) Pub. Date: Aug. 8, 2013

(54) ZERO BACKLASH GEAR STRUCTURE

(71) Applicants: Zhang-Hua Fong, Minxiong Township (TW); Szu-Hung Chen, Sanxing Township (TW)

(72) Inventors: Zhang-Hua Fong, Minxiong Township (TW); Szu-Hung Chen, Sanxing Township (TW)

(21) Appl. No.: 13/572,942

(22) Filed: Aug. 13, 2012

(30) Foreign Application Priority Data
Feb. 7, 2012 (TW) 101103919

(51) Int. Cl. F16H 55/18

(52) U.S. Cl. 74/409

(57) ABSTRACT

A zero backlash gear structure, comprising: an engaging element, a compound gear set, an elastic element, and a fixing element. Wherein, the engaging element is provided with a plurality of engaging slots. The compound gear set includes a compound gear, a gear shaft, and a spline; wherein, the compound gear is provided with at least two gears, said plurality of gears can be engaged to a plurality of engaging slots. Said fixing element is sleeved onto said gear shaft, to press against said plurality of gears and said elastic element. When backlash occurs, said elastic element is used to make said plurality of gears on said compound gear set to get close to each other automatically, so that said fixing element and said compound gear set can move in synchronism, thus achieving zero backlash in both forward and reverse rotations.

### BACKGROUND OF THE INVENTION

1. Field of the Invention

The present invention relates to a gear transmission structure, and in particular to a zero backlash gear structure.

2. The Prior Arts

In general, zero backlash gear is used extensively in high precision torque transmission mechanism, such as machine tool work-piece turning table. However, the conventional zero backlash gear structure has the following two shortcomings. Firstly, stiffness of the overall structure is insufficient, in causing minute time difference between output torques, thus it is not suitable to use in large horse power transmission mechanism. Secondly, during assembly, additional fixtures are required. Thirdly, size of the structure is rather large requiring more components, manufacturing cost is high, assembly efficiency is insufficient. As such, it can not be used to a single pair or multi-pair engaging elements. In other words, presently, the gear backlash regulating and eliminating mechanism is not able to provide various advantages required for a gear pair simultaneously: zero time difference in torque transmission, high stiffness, wide application, low production cost, and easy assembly.

Presently, the conventional zero backlash gear mechanisms can be classified roughly into the following two categories. The first category is formed by two motors in cooperation with a rotary encoder to control precision of forward and reverse rotations, yet for this kind of mechanism, not only the cost is high, but it is not suitable to use for multi engaging-element pairs. The second category is formed by a gear backlash eliminating mechanism, but this kind of mechanism has the problems that, when it is utilized in high torsion transmission, the reverse rotation of the mechanism could compress its displacement elastic element, to produce transmission angle delay, thus severely affecting overall performance of the mechanism. In addition, for this kind of gear backlash elimination mechanism, it requires large number of components, its manufacturing process is complicated, and its cost is high, thus having the shortcomings of large stiffness difference for forward and reverse rotations, high production cost, and inferior assembly efficiency, hereby adversely affecting precision of forward and reverse rotations, and reducing its market competitiveness.

With regard to the conventional gear backlash eliminating mechanism, refer to U.S. Patent No. 20040089089A1. Also, refer to FIG. 1 for a schematic diagram of structure of a gear backlash eliminating structure of the prior art. As shown in FIG. 1, when wear occurs between gears in operation, the upper gear 2, the lower gear 4, and the first gear 6 automatically produce relative rotations to eliminate the backlash generated between the second gear 7 and the third gear 8. However, the torsion generated must be greater than the torque transmitted by the gear pair, to achieve zero backlash without incurring transmission errors. In the structure mentioned above, the stiffness of the overall structure is not sufficient for the large horse power transmission mechanism. In addition, for this kind of design, during assembly, additional fixtures are required.

Therefore, presently, the design and performance of gear backlash eliminating mechanism is not quite satisfactory, and it has much room for improvements.

### SUMMARY OF THE INVENTION

In view of the problems and drawbacks of the prior art, the present invention provides a zero backlash gear structure of high precision, high stiffness, low cost, easy assembly, that is capable of eliminating backlash automatically for gear pairs, and is applicable to single pair and various planetary gears, to overcome the shortcomings of the prior art.

A major objective of the present invention is to provide zero backlash gear structure. Wherein, the helical angle difference between a spline and tooth form of a gear is used to cause a plurality of gears to make relative axial displacement by means of spline and gear shaft. When backlash occurs, an elastic element is used to make a plurality of gears on a compound gear set to get close to each other, so that when an engaging element and the plurality of gears are in forward or reverse rotations, they can be brought into actions directly, through the rigid contact between tooth face and the spline, in achieving the objective of eliminating gear transmission backlash, and high stiffness forward and reverse rotations, to raise the precision, smoothness, performance, service life, and competitiveness of the zero backlash gear mechanism. As such, the present invention is able to solve the problem of the conventional gear backlash eliminating mechanism that, the stiffness of mechanism is insufficient for a large horse power transmission mechanism, and therefore it can not realize zero torque transmission time difference.

Another objective of the present invention is to provide a zero backlash gear structure. Wherein, a flange is provided at the bottom of a compound gear set, such that the flange, spline, and gear shaft form integrally into a work-piece, to achieve the effect of zero backlash and zero torque transmission time difference. Since it is easier to produce and process a flange on a gear shaft, it has the advantage of mass production.

In order to achieve the above mentioned objective, the present invention provides a zero backlash gear structure, comprising at least: an engaging element, a compound gear set, an elastic element, and a fixing element. Wherein, the engaging element is provided with a plurality of engaging slots thereon. The compound gear set, includes a compound gear, a gear shaft, and a spline; wherein, the compound gear is provided with at least two gears, a first gear, and a second gear, the second gear is able to engage the spline, and the first gear and the second gear are able to engage a plurality of engaging slots. The elastic element is disposed on one side of the second gear, so that the second gear can get close to the first gear. And the fixing element is sleeved onto the gear shaft, to press against the second gear and the elastic element, so that the fixing element and the compound gear set are able to move in synchronism.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from this detailed descriptions.

### BRIEF DESCRIPTION OF THE DRAWINGS

The related drawings in connection with the detailed descriptions of the present invention to be made later are described briefly as follows, in which:

FIG. 1 is a schematic diagram of a gear backlash eliminating structure according to the prior art;

FIG. 2 is a schematic diagram of a zero backlash gear structure according to a first embodiment of the present invention;

FIG. 3 is an exploded view of a zero backlash gear structure according to a first embodiment of the present invention;

FIG. 4 is a schematic diagram of a compound gear set according to the present invention;

FIG. 5 is a schematic diagram of a zero backlash gear structure according to a second embodiment of the present invention; and

FIG. 6 is an exploded view of a zero backlash gear structure according to a second embodiment of the present invention.

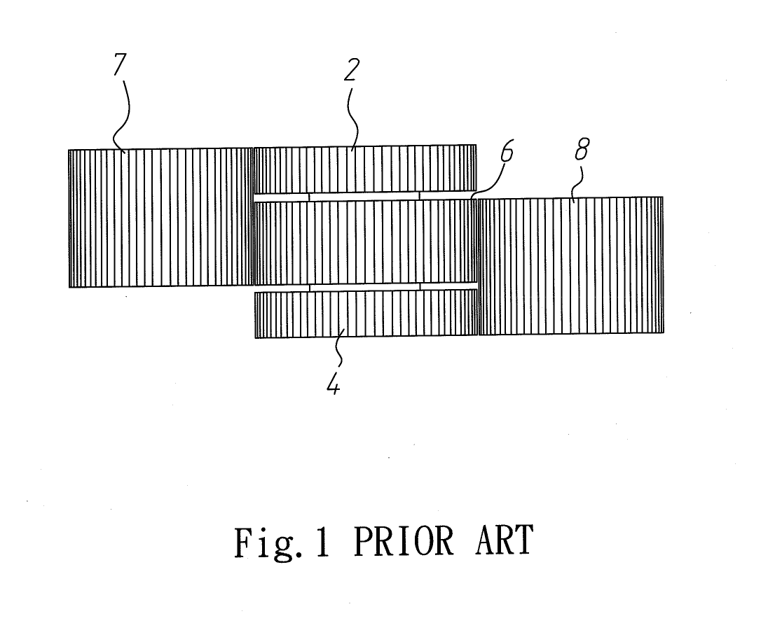

### DETAILED DESCRIPTION OF THE PREFERRED EMBODIMENT

The purpose, construction, features, functions and advantages of the present invention can be appreciated and understood more thoroughly through the following detailed description with reference to the attached drawings.

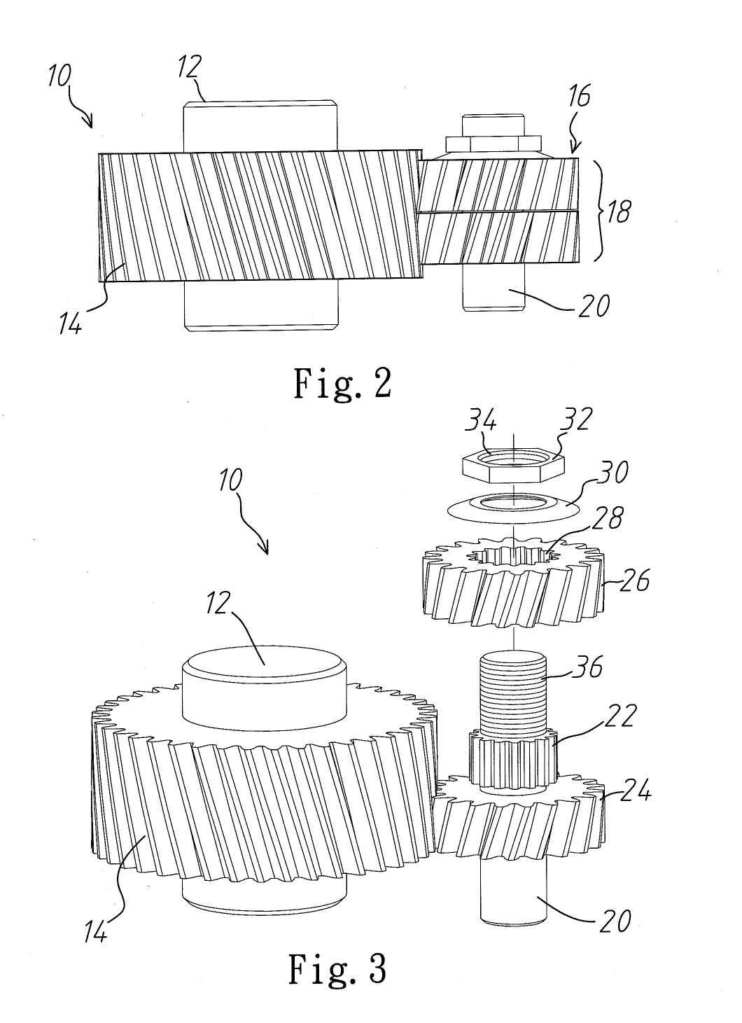

Refer to FIG. 2 for a schematic diagram of a zero backlash gear structure according to a first embodiment of the present invention; and FIG. 3 for an exploded view of a zero backlash gear structure according to a first embodiment of the present invention. As shown in FIGS. 2 and 3, the present invention provides a zero backlash gear structure 10, comprising at least an engaging element 12, a compound gear set 16, an elastic element 30, and a fixing element 32. Wherein, the engaging element 12 can be a gear or a gear rack (not shown), on the engaging element 12 is provided with a plurality of engaging slots 14, wherein, the engaging element 12 and the engaging slots 14 can be realized as components sleeved together or an integral workpiece. The compound gear set 16 includes a compound gear 18, a gear shaft 20, and a spline 22. Wherein, the compound gear 18 is provided with at least two gears, and in the first embodiment, the at least two gears are a first gear 24 and a second gear 26. In such a structure, the first gear 24 and the second gear 26 are helical gears. The gear shaft 20, spline 22, and the first gear 24 are formed into an integral work-piece. The second gear 26 is provided with a first internal gear 28, that can be sleeved on the splice 22, so that the second gear 26 may engage the spline 22. The width of the engaging slot 14 extends across the axial distance of the first gear 24 and the second gear 26, so that the first gear 24 and the second gear 26 can engage entirely the plurality of engaging slots 14. The elastic element 30 is disposed on a side of the second gear 26, such that it can be a washer, and is made of metal, plastic, rubber, or paper fiber. The fixing element 32 is provided with female threads 35, and one side of the compound gear set 16 is provided with male threads 36, such that the fixing element 32 can use the female threads 34 and the male threads 36 to sleeve on the gear shaft 20, to press against the second gear 26 and the elastic element 30, so that the fixing element 32 and the compound gear set 16 may rotate forward or reverse, or move forward or reverse in synchronism. When the engaging elements 12 is a gear, the fixing element 32 and the compound gear set 16 can rotate forward or reverse; and when the engaging elements 12 is a gear rack, the fixing element 32 and the compound gear set 16 can rotate forward or reverse.

As shown in FIGS. 2 and 3, when the first gear 24 and the second gear 26 on the gear shaft 20 engage the engaging element 12 simultaneously, the tooth forms between the engaging element 12 and the first gear 24 and the second gear 26 will produce gap. Since in the present invention, the tooth forms of the spline 22 and the second gear 26 have helical angle difference, so that the first gear 24 may press tightly against the second gear 26. Then, the elastic element 30 is used to press the first gear 24 and the second gear 26 to move close to each other. Since the first gear 24, the gear shaft 20, and the spline 22 form into an integral work-piece, so that the second gear 26 may produce relative axial displacement on gear shaft 20, and move close to the first gear 24. The axial displacement and helical angle difference of the second gear 26 can be used to adjust the relative rotation angle of the engaging element 12, and the first gear 24 and the second gear 26 on the zero backlash gear structure 10, so that the first gear 24 and the second gear 26 may clamp tightly on the left and right tooth faces of the engaging element 12, to eliminate engaging gap. Since the first gear 24 and the second gear 26 use at the same time the helical angle difference between the spline 22 and the first gear 24 and the second gear 26, to achieve their forward and reverse rotations, and that can be brought about directly, through the rigid contact between the spline 22, and the tooth faces of the first gear 24 and the second gear 26, in achieving the objective of eliminating transmission backlash between the engaging element 12, and the first gear 24 and the second gear 26, and realizing high stiffness forward and reverse rotations, so that both the forward and reverse rotations can achieve zero backlash and zero torque transmission time difference.

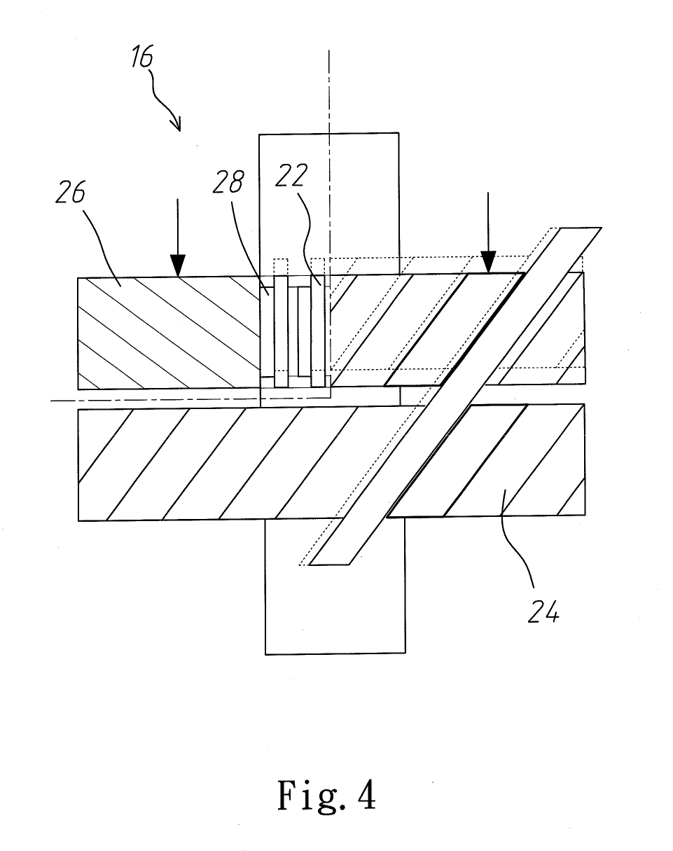

Subsequently, refer to FIGS. 2, 3, and 4 at the same time to describe the structure of a compound gear set according to the present invention. As shown in FIG. 4, in the actual operation of the zero backlash gear structure 10, the input power is provided at the engaging element 12 or the compound gear set 16. When input power is provided at the engaging element 12, in forward rotation, it may bring the first gear 24 to output power directly; while in reverse rotation, the engaging element 12 brings the second gear 26 into motion, and through the first internal gear 28 of the second gear 26 and the spline 22, to bring the first gear 24 to output power. Since the first internal gear 28 of the second gear 26, the first gear 24, and the spline 22 are in close contact, so that zero backlash can be achieved for the zero backlash gear structure 10 in both forward or reverse rotations, without incurring transmission angle delay, hereby improving significantly the stiffness of the zero backlash gear structure 10, in achieving eliminating backlash, to obtain high precision and low assembly tolerance automatically.

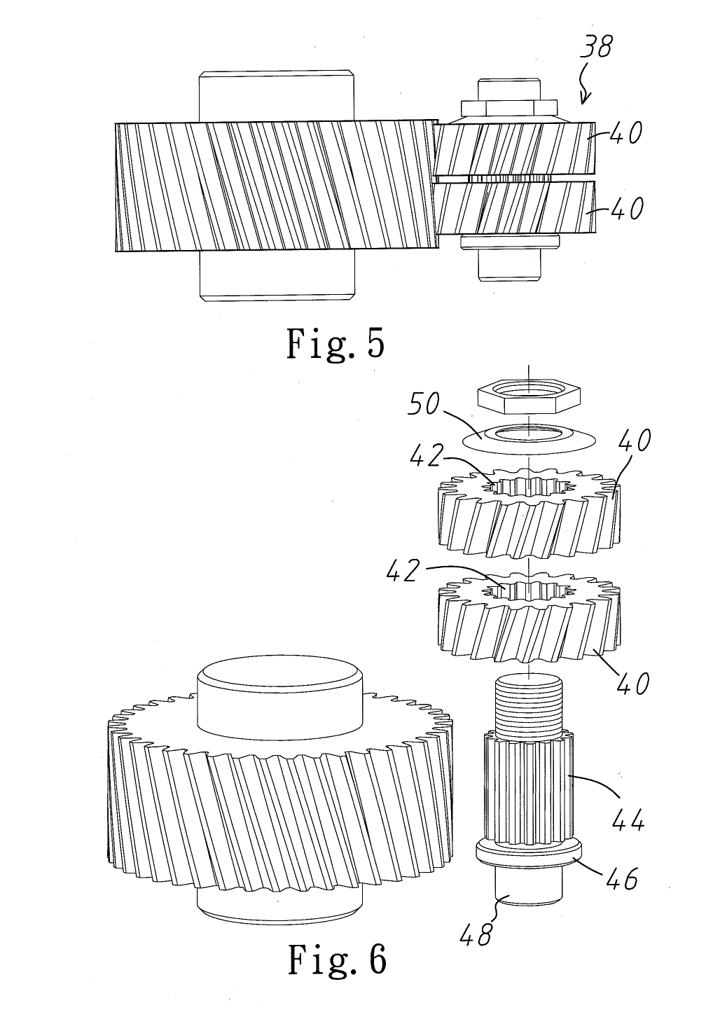

Finally, refer to FIGS. 5 and 6 respectively for a schematic diagram of a zero backlash gear structure according to a second embodiment of the present invention; and an exploded view of a zero backlash gear structure according to a second embodiment of the present invention. As shown in FIGS. 5 and 6, in the first embodiment, the first gear 24, the gear shaft 20, and the spline 22 form into an integral work-piece. However, in the second embodiment, in order to make it easier to produce and process, a plurality of gears 40 are provided on the compound gear set 38 for implementation. Each of the plurality of gears 40 is provided with a second internal gear 42, and the plurality of second internal gears 42 are able to engage the spline 44, so that the width of the spline 44 encompasses at least the axial distance of the plurality of gears 40. The bottom of the compound gear set 38 is provided with a flange 46, such that the flange 46, the spline 44, and the gear shaft 48 form integrally into a work-piece. The disposition of the flange 46 is to make the plurality of gears 40 to engage and connect to each other. Similarly, the other end of the compound gear set 38 is provided with an elastic element 50, to make the gears 40 to get close to each other. Therefore, when the gear 40 closest to the flange 46 presses tightly in the direction of the flange 46, at this time the flange 46 can act as the first gear 24 in the first embodiment pressing tightly against the gear 40. Its principle of operation is the same as the first embodiment, thus it will not be repeated here for brevity. As such, the second embodiment is able to achieve zero backlash and zero torque transmission time difference as in the first embodiment. In the second embodiment, the flange 46 is provided at the gear shaft 48, to make it easier to produce and process, hereby having the advantage of mass production.

Through the application of the present invention, as described in the first and the second embodiments, when the backlash between the gears occurs, the zero backlash gear structure is capable of eliminating automatically backlashes between all the gears to reach zero backlash, raising precision of engagement, reducing vibration and noise, and having the advantages of better stiffness during forward and reverse rotations, easy to assemble and requiring fewer components, and better market competitiveness.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A zero backlash gear structure, comprising at least:
an engaging element, provided with a plurality of engaging slots
a compound gear set, including a compound gear, a gear shaft, and a spline; said compound gear is provided with at least two gears, a first gear, and a second gear, said second gear engages said spline, and said first gear and said second gear engage said engaging slots.
an elastic element, disposed on one side of said second gear, so that said second gear is close to said first gear; and
a fixing element, sleeved onto said gear shaft, to press against said second gear and said elastic element, so that said fixing element and said compound gear set move in synchronism.

2. The zero backlash gear structure as claimed in claim 1, wherein said engaging element and said engaging slots form integrally into a work-piece.

3. The zero backlash gear structure as claimed in claim 2, wherein said second gear is provided with a first internal gear, and said first internal gear is engaged to said spline.

4. The zero backlash gear structure as claimed in claim 1, wherein said first gear, said gear shaft, and said spline form integrally into a work-piece.

5. The zero backlash gear structure as claimed in claim 1, wherein said engaging element is said gear or a gear rack.

6. The zero backlash gear structure as claimed in claim 1, wherein width of said engaging slots encompasses at least axial distance between said first gear and said second gear.

7. The zero backlash gear structure as claimed in claim 1, wherein said first gear and said second gear are helical gears.

8. The zero backlash gear structure as claimed in claim 1, wherein a plurality of said gears are provided on said compound gear set, said gears are each provided with a second internal gear, said second internal gear engages said spline, bottom of said compound gear set is provided with a flange, which makes said gears to press and contact each other, other end of said compound gear set is provided with said elastic element, to make said gears to get close to each other.

9. The zero backlash gear structure as claimed in claim 8, wherein said flange, said spline, and said gear shaft form integrally into a work-piece.

10. The zero backlash gear structure as claimed in claim 1, wherein one side of said compound gear set is provided with male threads, said fixing element is provided with female threads, said male threads are engaged to said female threads.

11. The zero backlash gear structure as claimed in claim 1, wherein said elastic element is a washer, made of metal, plastic, rubber, or paper fiber.
